(19) United States
(12) Patent Application Publication
(10) Pub. No.: US 2006/0120323 A1
(43) Pub. Date: Jun. 8, 2006

(54) Media access controller with enhanced data unit retransmission for broadband wireless communication and method

(76) Inventors: Fengji Ye, Troy, NY (US); Sanjay Bakshi, Beaverton, OR (US)

Correspondence Address: SCHWEGMAN, LUNDBERG, WOESSNER & KLUTH, 121 S. 8TH STREET, SUITE 1600, MINNEAPOLIS, MN, 55402, US

(21) Appl. No.: 11/005,801

(22) Filed: Dec. 7, 2004

(51) Int. Cl. H04Q 7/00

(52) U.S. Cl. 370/329; 370/392

(57) ABSTRACT

A media access controller (MAC) of a broadband wireless communication device generates a data unit payload from fragments of more than one service data unit, constructs an initial data unit from the data unit payload, and combines the initial data unit with data units of another service flow for subsequent transmission. The MAC reconstructs a new data unit when at least a portion of one of the fragments of the initial data unit is not acknowledged as being received. In some embodiments, the new data unit is reconstructed using blocks of a same fragment and blocks of an untransmitted fragment. The same fragment may include both blocks that were acknowledged as being received and blocks that were not acknowledged as being received. In some embodiments, portions of the initial data unit payload are rearranged to generate smaller data units for retransmission when channel conditions have degraded.

### RELATED APPLICATIONS

This patent application is related to U.S. patent application Ser. No. 10/[TBD], entitled “[TBD]” having attorney docket number 884.D92US1 (P20827) and filed concurrently herewith.

### TECHNICAL FIELD

Embodiments of the present invention pertain to wireless communications. Some embodiments of the present invention relate to media access control and broadband wireless communications.

### BACKGROUND

In many conventional broadband wireless communication systems, a receiving station may provide an acknowledgement to a transmitting station when a packet is successfully received. Some packets may be corrupted in the wireless channel and may not be received successfully by the receiving station. These packets that are not received successfully may be retransmitted. Some conventional broadband wireless systems, including some WiMax and broadband wireless access (BWA) systems, implement an automatic repeat request process or an automatic retransmission request (ARQ) process within their media access controller (MAC) to retransmit packets that were not successfully received. This is sometimes referred to as an automatic repeat request process. These processes may be overhead-intensive and may result in unnecessary timeouts.

### BRIEF DESCRIPTION OF THE DRAWINGS

FIG. 1 is a block diagram of a broadband wireless communication device in accordance with some embodiments of the present invention;

FIG. 2 is a flow chart of a service flow scheduling and retransmission request procedure in accordance with some embodiments of the present invention; and

FIG. 3 illustrates a data unit suitable for use with some embodiments of the present invention.

### DETAILED DESCRIPTION

The following description and the drawings illustrate specific embodiments of the invention sufficiently to enable those skilled in the art to practice them. Other embodiments may incorporate structural, logical, electrical, process, and other changes. Examples merely typify possible variations. Individual components and functions are optional unless explicitly required, and the sequence of operations may vary. Portions and features of some embodiments may be included in or substituted for those of others. Embodiments of the invention set forth in the claims encompass all available equivalents of those claims. Embodiments of the invention may be referred to, individually or collectively, herein by the term “invention” merely for convenience and without intending to voluntarily limit the scope of this application to any single invention or inventive concept if more than one is in fact disclosed.

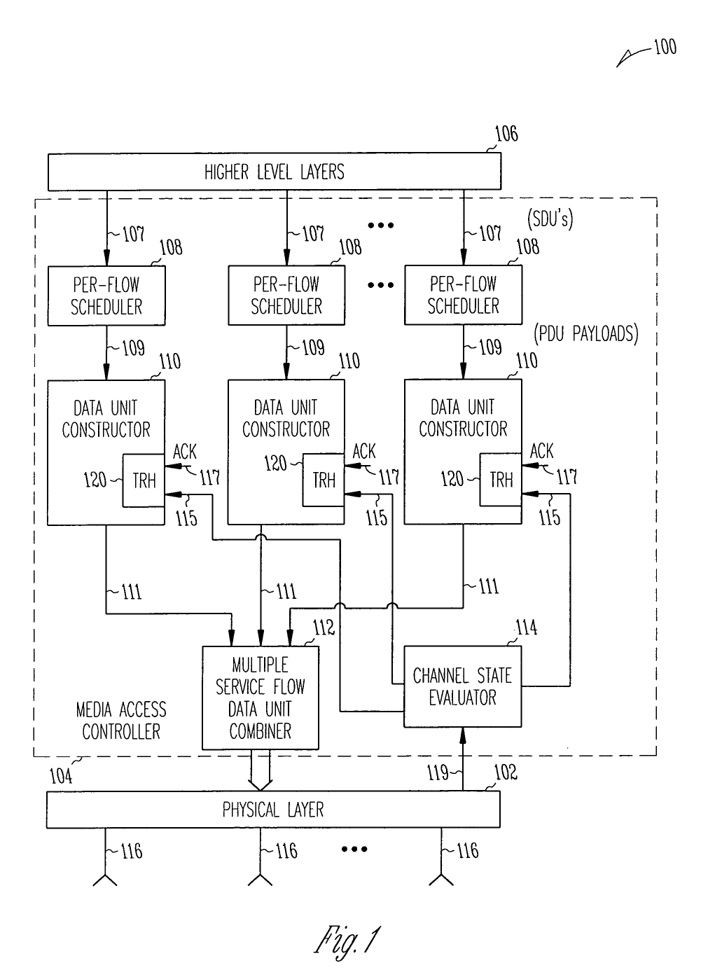

FIG. 1 is a block diagram of a broadband wireless communication device in accordance with some embodiments of the present invention. Broadband wireless communication device 100 may be viewed as comprising a plurality of layers of a protocol stack including physical layer 102, media access controller (MAC) 104, and one or more of higher-level layers 106.

In some embodiments, broadband wireless communication device 100 may transmit physical-layer bursts comprising data units of one or more service flows to one or more receiving stations. Examples of different service flows include voice, data, multimedia or streamed video, and Internet communications, although the scope of the invention is not limited in this respect.

In some embodiments, media access controller 104 may include other elements not illustrated including a convergence sublayer (CS) to construct MAC service data units (SDUs) from higher-level layers 106. In these embodiments, media access controller 104 illustrated in FIG. 1 may correspond to a media access controller common part sublayer (CPS) that may receive the MAC SDUs from the CS, although the scope of the invention is not limited in this respect.

In accordance with some embodiments of the present invention, media access controller 104 may comprise one of per-flow schedulers 108 associated with each of a plurality of service flows. Per-flow schedulers 108 receive service data units 107 for their associated service flow from higher-level layers 106 and may, among other things, generate data unit payloads 109. In some embodiments, service data units 107 may be MAC SDUs, although the scope of the invention is not limited in this respect. Media access controller 104 may also comprise data unit constructors (DUCs) 110 associated with each of the service flows to, among other things, construct data units 111 from data unit payloads 109. Data unit constructors 110 may comprise transmission request handlers (TRHs) 120 to reconstruct at least portions or fragments of data units for retransmission when the portions or fragments are not successfully received by a receiving station. In some embodiments, transmission request handlers 120 may assist data unit constructors 110 with the construction of data units.

Media access controller 104 may also comprise multiple service flow data unit combiner 112 to combine data units 111 from the multiple service flows for transmission in a physical-layer burst by physical layer 102. In some embodiments, data unit combiner 112 may combine data units 111 provided by data unit constructors 110. The operations of media access controller 104 are described in more detail below.

In some embodiments, per-flow schedulers 108 may generate protocol data unit (PDU) payloads, data unit constructors 110 may construct PDUs and multiple service flow data unit combiner 112 may combine PDUs of multiple service flows, although the scope of the invention is not limited in this respect. In some embodiments, transmission request handlers 120 may be automatic retransmission request (ARQ) handlers that implement an ARQ process, although the scope of the invention is not limited in this respect. In some embodiments, transmission request handlers 120 may implement an automatic repeat request process, although the scope of the invention is not limited in this respect.

In some embodiments, signals 117 may be provided to transmission request handlers 120 to acknowledge successful receipt of data units or fragments of the associated data flow. In some embodiments, signals 117 may include an acknowledgement signal (e.g., an ACK) issued for a particular fragment or data unit, although the scope of the invention is not limited in this respect. In some embodiments, signals 117 may include a negative acknowledgement (e.g., a NACK) which may be issued when a transmitted fragment or data unit is not acknowledged within a predetermined period of time discussed in more detail below.

In some embodiments, one of per-flow schedulers 108 may generate a data unit payload from fragments of more than one service data unit. The associated one of data unit constructors 110 may construct an initial data unit from the data unit payload and data unit combiner 112 may combine the initial data unit with data units of another service flow for subsequent transmission. In these embodiments, the associated one of transmission request handlers 120 may reconstruct a new data unit when at least a portion of one of the fragments of the initial data unit is not acknowledged as being received.

In some embodiments, the new data unit may be constructed using blocks of the same fragment and an untransmitted fragment. In some embodiments, the same fragment may include both blocks that were acknowledged as being received and blocks that were not acknowledged as being received, although the scope of the invention is not limited in this respect.

In some embodiments, data unit combiner 112 may combine the initial data unit with data units of other service flows for subsequent transmission within a single physical-layer burst through a wireless communication channel to a receiving station. When conditions of the channel are determined to be degraded per signal 115, the associated one of transmission request handlers 120 may rearrange portions of the initial data unit payload to generate smaller data units when the initial data unit is not acknowledged as being received by the associated one of signals 117. When the conditions of the channel are not determined to be degraded, the associated one of transmission request handlers 120 may refrain from rearranging the portions of the initial data unit payload and may provide the initial data unit to data unit combiner 112 for recombining with data units of other service flows when the initial data unit is not acknowledged as being received.

In some embodiments, physical layer 102 may have a variable burst size. In these embodiments, data unit combiner 112 may combine data units provided by data unit constructors 110 and/or transmission request handlers 120 from the plurality of service flows into single physical-layer bursts of varying burst sizes.

Although broadband wireless communication device 100 is illustrated as having several separate functional elements, one or more of the functional elements may be combined and may be implemented by combinations of software-configured elements, such as processing elements including digital signal processors (DSPs), and/or other hardware elements. For example, media access controller 104 may comprise one or more processing elements such as one or more microprocessors, DSPs, application specific integrated circuits (ASICs), and combinations of various hardware and logic circuitry for performing at least the functions described herein. In some embodiments, the functional elements of broadband wireless communication device 100 may refer to one or more processes operating on one or more processing elements.

In some embodiments, broadband wireless communication device 100 may communicate multicarrier communication signals, such as orthogonal frequency division multiplexed (OFDM) signals or orthogonal frequency division multiple access (OFDMA) signals comprising a plurality of orthogonal subcarriers. In some embodiments, the orthogonal subcarriers may be closely spaced OFDM subcarriers, although the scope of the invention is not limited in this respect. In some embodiments, broadband wireless communication device 100 may communicate with one or more other broadband communication stations over an OFDMA communication channel. In some embodiments, broadband wireless communication device 100 maybe a multiple-input multiple-output (MIMO) communication device and may use two or more of antennas 116 to transmit multiple data streams, although the scope of the invention is not limited in this respect. Antennas 116 may comprise one or more directional or omnidirectional antennas, including, for example, dipole antennas, monopole antennas, patch antennas, loop antennas, microstrip antennas or other types of antennas suitable for reception and/or transmission of multicarrier radio-frequency signals.

In some embodiments, broadband wireless communication device 100 may transmit and/or receive RF communications in accordance with specific communication standards, such as the Institute of Electrical and Electronics Engineers (IEEE) standards including the IEEE 802.16 standards for wireless metropolitan area networks (WMANs), although device 100 may also be suitable to transmit and/or receive communications in accordance with other techniques.

In some embodiments, broadband wireless communication device 100 may be a broadband communication station, a broadband transmitting station, a personal digital assistant (PDA), a laptop or portable computer with wireless communication capability, a web tablet, a wireless telephone, a wireless headset, a pager, an instant messaging device, a digital camera, an access point or other communication device that may receive and/or transmit information wirelessly.

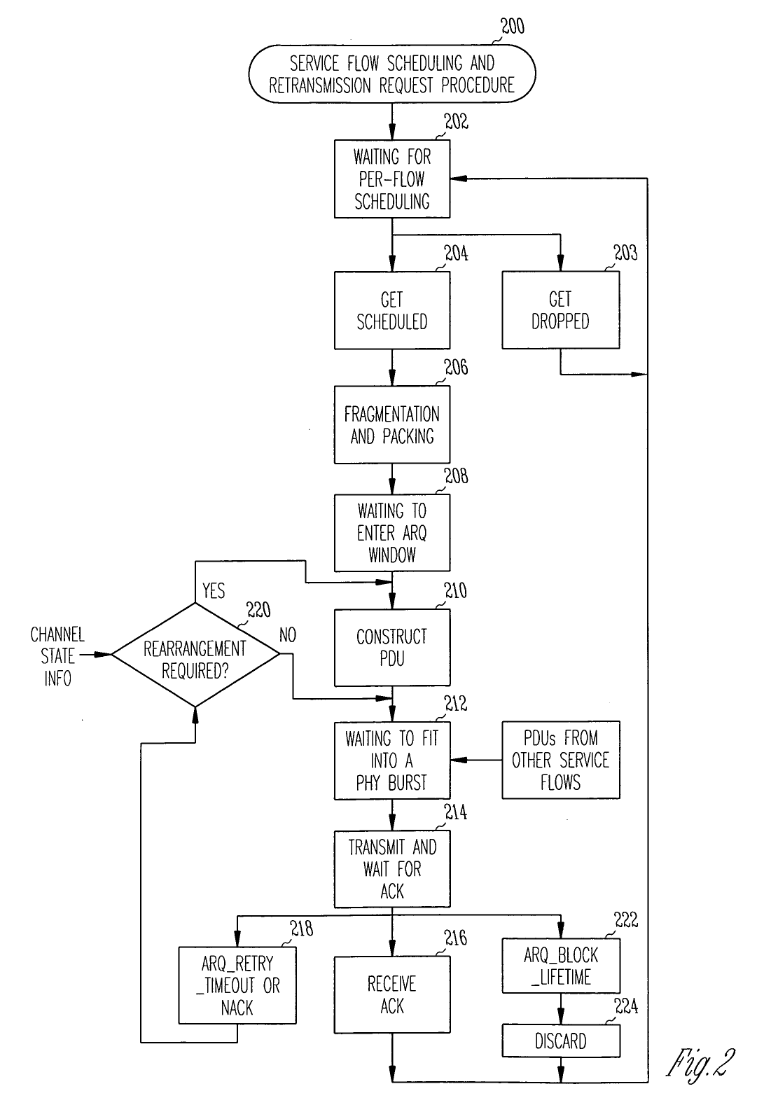

FIG. 2 is a flow chart of a service flow scheduling and retransmission request procedure in accordance with some embodiments of the present invention. Service flow scheduling and retransmission request procedure 200 may be performed by media access controller 104 (FIG. 1), although other media access controller configurations may also be used.

Operation 202 comprises waiting for per-flow scheduling. In some embodiments, operation 202 may be performed by one of per-flow schedulers 108 (FIG. 1) when a service data unit is received from higher-level layers 106 (FIG. 1). The service data unit may be associated with a particular service flow, and scheduler 108 (FIG. 1) receiving the service data unit may also be associated with that service flow.

Operation 204 comprises scheduling the received service data unit for pending transmission within a physical-layer burst. When the service data unit is not able to be scheduled, the service data unit may be dropped in operation 203. In some embodiments, operation 203 may drop packets when the number of service data units associated with a particular service flow exceeds the rate at which they can be transmitted by the physical layer or a buffer holding the service data units for scheduling becomes full. In some embodiments, operation 203 may drop packets even when the transmission rate can be accommodated by the physical layer. For example, packets may be dropped when the scheduling queue is too long compared to a maximum latency that is set for the quality-of-service associated with a particular service flow. In some embodiments, operation 204 may be performed by schedulers 108 (FIG. 1).

Once a received service data unit is scheduled in operation 204, operation 206 may be performed. Operation 206 comprises fragmenting and packing the service data unit to generate data unit payloads. In some embodiments, operation 206 may comprise separating a service data unit into a plurality of fragments, combining the fragments with fragments of other service data units of the same service flow, and packing the combined fragments into data unit payloads. In some embodiments, operation 206 may be performed by schedulers 108 (FIG. 1) to generate data unit payloads 109 (FIG. 1). In some embodiments, each scheduler 108 (FIG. 1) may generate data unit payloads 109 (FIG. 1) for an associated service flow.

Operation 208 comprises waiting to enter a transmission request window. In some embodiments, the transmission request window may be an ARQ transmission request window, although the scope of the invention is not limited in this respect. The transmission request window may be used to buffer unacknowledged packets. Operation 208 may be performed by one of transmission request handlers 120 (FIG. 1) for the associated service flow.

In some embodiments, the transmission request window may be a linear (i.e., one dimensional) buffer for storing flags or pointers to transmitted but not yet acknowledged packets or data units for a particular service flow. In some embodiments, the transmission request window may represent a range that holds block serial numbers of unacknowledged packets. In some embodiments, the transmission request window may set the pace for sending out new packets by not allowing the size of the window (e.g., number of block serial numbers in the range) to exceed a maximum window size. In some embodiments, once a packet is acknowledged, the window may advance to allow a next data unit payload to enter allowing a next data unit to be constructed.

In some embodiments, each of transmission request handlers 120 (FIG. 1) may maintain a transmission request window to perform retransmissions for at least portions of data units of an associated service flow that are not acknowledged as being received during the transmission request window. Once a data unit payload enters a transmission request window in operation 208, operation 210 may be performed in which a data unit is constructed from the data unit payload generated in operation 206 and entered in the transmission request window in operation 208. Operation 210 may be performed by data unit constructors 110 (FIG. 1) and may include adding headers and or subheaders to the payload. In some embodiments, operation 210 may include encrypting the payload, although the scope of the invention is not limited in this respect.

Operation 212 comprises combining data units generated in operation 210 from different service flows based on a burst size of the physical layer. In some embodiments, data units of different service flows may be concatenated. In some embodiments, operation 212 may be performed by service flow data unit combiner 112 (FIG. 1).

Operation 214 comprises transmitting the combined data units in a physical-layer burst to one or more receiving stations. Operation 214 may be performed by physical layer 102 (FIG. 1) and may comprise transmitting the combined data units of more than one service flow using OFDMA communication signals, although the scope of the invention is not limited in this respect. Operation 214 may also include waiting to receive an acknowledgement from the one or more receiving stations for fragments of transmitted data units.

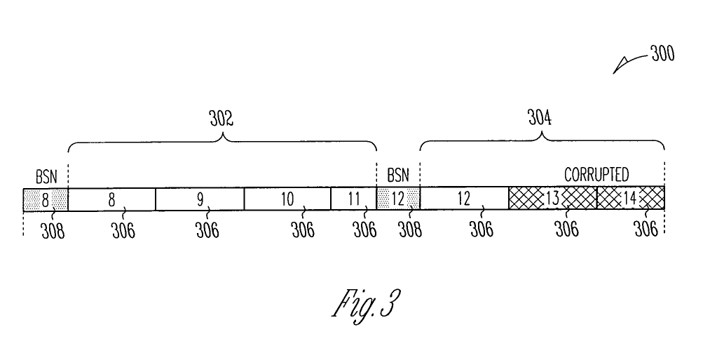

FIG. 3 illustrates a data unit suitable for use with some embodiments of the present invention. Data unit 300 may be transmitted as part of physical-layer burst in operation 214 (FIG. 2). Data unit 300 may be a portion of a data unit and includes fragments 302 and 304. In some embodiments, each fragment may have a block serial number (BSN) indicating logical boundaries between the fragments. Fragments 302 and 304 may comprise individual blocks 306. In some embodiments, blocks 306 may be referred to as ARQ blocks, although the scope of the invention is not limited in this respect. In some embodiments, transmission request handlers 120 (FIG. 1) may wait for an acknowledgement for each fragment 302 or 304 or cluster (i.e., rather than individual blocks 306), although the scope of the invention is not limited in this respect. In some embodiments, the order of the fragments may be maintained with respect to their service data unit, although the scope of the invention is not limited in this respect.

In some embodiments, an acknowledgement from a receiving station may acknowledge a successful receipt of one or more of the fragments. In some embodiments, a negative acknowledgement (e.g., a NACK) may be issued when a transmitted packet has not been acknowledged within a predetermined period of time. In some embodiments, a negative acknowledgement may be received when one or more of the blocks of a fragment are received but the receiving station is unable to correctly decode the blocks (i.e., errors are generated after decoding and/or verification).

Referring back to FIG. 2, when an acknowledgement for a fragment is received within a predetermined period of time (e.g., within an ARQ transmission request window) in operation 216, the transmission may be considered complete no further action may be necessary with respect to the acknowledged fragment. The transmission request window may be ready to advance after receiving the acknowledgement.

When an acknowledgement is not received within a predetermined period of time defined for a block lifetime as indicated in operation 222, the block or fragment may be discarded in operation 224. In some embodiments, the predetermined period of time may be an ARQ block lifetime (e.g., ARQ_BLOCK_LIFETIME) period, although the scope of the invention is not limited in this respect.

Operation 218 may call for a retransmission of one or more fragments for which an acknowledgement is not received within a predetermined period of time defined for a retry timeout or when a negative acknowledgement is received. In some embodiments, the predetermined period of time may be an ARQ retry timeout (e.g., ARQ_RETRY_TIMEOUT) period, although the scope of the invention is not limited in this respect. Operation 220 may determine whether or not rearrangement of the data unit is required. When rearrangement is not required, operation 212 may be repeated and the data unit may be combined and retransmitted with one or more other data units from other service flows in operation 214. When rearrangement is determined to be required, operation 210 may reconstruct the data unit, operation 212 may be repeated and the reconstructed data unit may be retransmitted with one or more other data units from other service flows in operation 214.

In some embodiments, operation 220 may determine whether or not to rearrange a data unit based on channel state information. Channel state information 115 (FIG. 1) associated with a particular service flow may be provided by channel state evaluator 114 (FIG. 1). For example, when the channel degrades resulting, for example, in higher packet error rates, smaller data units may be constructed in operation 210. In some embodiments, channel state evaluator 114 (FIG. 1) may receive information 119 (FIG. 1) from physical layer 102 (FIG. 1), while in other embodiments, channel state evaluator 114 (FIG. 1) may be part of physical layer 102 (FIG. 1), although the scope of the invention is not limited in this respect.

In some embodiments, the transmission request handlers reconstruct a new data unit when at least a portion of one of the fragments of an initial data unit is not acknowledged as being received. The new data unit may be constructed using blocks of a same fragment and an untransmitted fragment. In some embodiments, the same fragment that is retransmitted may include both blocks that were acknowledged as being received and blocks that were not acknowledged as being received, although the scope of the invention is not limited in this respect.

Although the individual operations of procedure 200 are illustrated and described as separate operations, one or more of the individual operations may be performed concurrently, and nothing requires that the operations be performed in the order illustrated. Procedure 200 may improve the efficiency of automatic retransmission request, especially in WiMax and broadband wireless communication systems, by reducing the overhead and protecting the media access controller from unnecessary timeouts. Separate per flow-schedulers 108 (FIG. 1) and their placement above transmission request handlers 120 (FIG. 1) in the operational flow helps prevent dropped packets by the schedulers from affecting ARQ operations. In this way, retransmission requests may be performed promptly and may avoid further timeouts. In some embodiments, service data units may be fragmented in operation 206 prior to entering the retransmission window allowing for retransmission of clusters, such as fragments 302 (FIG. 3) and 304 (FIG. 3).

In some embodiments, when one or more blocks of cluster are detected as being corrupted at the receiving station, the corrupted cluster may be retransmitted in its entirety, with or without data unit rearrangement indicated in operation 220. In some embodiments, block sequence numbers (BSNs) 308 (FIG. 3) may be carried in the fragmentation and packing subheaders and may identify a cluster as shown. As illustrated in the example of FIG. 3, blocks numbered with sequence numbers 13 and 14 may have gotten corrupted at the receiving station. In this situation, a negative acknowledgement may be issued by the receiving station for fragment 304 and fragment 304 may be packed into a new data unit and retransmitted. As can be seen, acknowledgement traffic may be reduced by the elimination of acknowledgements for individual blocks 306. This is achievable at least because retransmission acknowledgement management is performed after scheduling and fragmentation.

Unless specifically stated otherwise, terms such as processing, computing, calculating, determining, displaying, or the like, may refer to an action and/or process of one or more processing or computing systems or similar devices that may manipulate and transform data represented as physical (e.g., electronic) quantities within a processing system's registers and memory into other data similarly represented as physical quantities within the processing system's registers or memories, or other such information storage, transmission or display devices. Furthermore, as used herein, computing device includes one or more processing elements coupled with computer-readable memory that may be volatile or non-volatile memory or a combination thereof.

Embodiments of the invention may be implemented in one or a combination of hardware, firmware and software. Embodiments of the invention may also be implemented as instructions stored on a machine-readable medium, which may be read and executed by at least one processor to perform the operations described herein. A machine-readable medium may include any mechanism for storing or transmitting information in a form readable by a machine (e.g., a computer). For example, a machine-readable medium may include read-only memory (ROM), random-access memory (RAM), magnetic disk storage media, optical storage media, flash-memory devices, electrical, optical, acoustical or other form of propagated signals (e.g., carrier waves, infrared signals, digital signals, etc.), and others.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims.

In the foregoing detailed description, various features are occasionally grouped together in a single embodiment for the purpose of streamlining the disclosure. This method of disclosure is not to be interpreted as reflecting an intention that the claimed embodiments of the subject matter require more features than are expressly recited in each claim. Rather, as the following claims reflect, invention may lie in less than all features of a single disclosed embodiment. Thus the following claims are hereby incorporated into the detailed description, with each claim standing on its own as a separate preferred embodiment.

What is claimed is:

1. A media access controller comprising:
a per-flow scheduler to generate a data unit payload from fragments of more than one service data unit of a service flow;
a data unit constructor to construct an initial data unit from the data unit payload;
a data unit combiner to combine the initial data unit with data units of another service flow for subsequent transmission; and
a transmission request handler to reconstruct a new data unit when at least a portion of one of the fragments of the initial data unit is not acknowledged as being received.

2. The media access controller of claim 1 wherein the new data unit is constructed using blocks of a same fragment and an untransmitted fragment, the same fragment including both blocks that were acknowledged as being received and blocks that were not acknowledged as being received.

3. The media access controller of claim 1 wherein the data unit combiner combines the initial data unit with data units of other service flows for subsequent transmission within a single physical-layer burst through a wireless communication channel to a receiving station, and
wherein when conditions of the channel are determined to be degraded, the transmission request handler rearranges portions of the initial data unit payload to generate smaller data units when the initial data unit is not acknowledged as being received.

4. The media access controller of claim 3 wherein when the conditions of the channel are not determined to be degraded, the transmission request handler refrains from rearranging the portions and provides the initial data unit to the data unit combiner for recombining with data units of other service flows when the initial data unit is not acknowledged as being received.

5. The media access controller of claim 4 wherein the wireless communication channel comprises an orthogonal frequency division multiple access channel.

6. The media access controller of claim 1 wherein the service flow is one of a plurality of service flows, wherein the per-flow scheduler, the data unit constructor and the transmission request handler are associated with one of the service flows of the plurality,
wherein the media access controller further comprises a per flow scheduler, a data unit constructor and a transmission request handler for each of the service flows,
wherein the per-flow schedulers each receive a plurality of service data units for an associated one of the service flows and generate data unit payloads for the associated service flow, and
wherein the data unit combiner combines data units provided by the transmission request handlers from the plurality of service flows into a single physical-layer burst.

7. The media access controller of claim 6 wherein the plurality of service flows comprise one or more of a voice, data, multimedia, streaming video and internet communication.

8. The media access controller of claim 6 wherein the media access controller is one layer of a protocol stack,
wherein the schedulers receive the service data units for the associated service flow from a higher-level layer of the protocol stack, and
wherein the data unit combiner provides the combined data units to a physical layer of the protocol stack for transmission to one or more receiving stations in the single physical-layer burst.

9. The media access controller of claim 8 wherein the physical layer comprises a multicarrier transmitter to transmit orthogonal frequency division multiple access communication signals comprising a plurality of substantially orthogonal subcarriers.

10. The media access controller of claim 8 wherein the physical layer has a variable burst size, and
wherein the data unit combiner combines data units provided by the transmission request handlers from the plurality of service flows into physical-layer bursts of varying burst sizes.

11. The media access controller of claim 1 wherein the transmission request handler maintains a request transmission window of a predetermined size to buffer blocks of transmitted data units until either an acknowledgement is received or a block lifetime expires,
wherein the data unit constructor constructs the initial data unit after entering the request transmission window for the initial data unit,
wherein the transmission request handler advances the request transmission window when at either an acknowledgement for a transmitted block is received or a block lifetime for the transmitted block expires.

12. The media access controller of claim 1 wherein the scheduler separates received service data units into a plurality of the fragments and combines the fragments of the one or more service data units into one or more data unit payloads,
wherein the data unit constructor constructs the initial data unit at least by adding a header to the data unit payload, and
wherein the transmission request handler reconstructs the new data unit at least by adding a header to a new data unit payload comprising at least the portion of one of the fragments of the initial data unit is not acknowledged as being received.

13. A method comprising:
generating a data unit payload from fragments of more than one service data unit of a service flow;
constructing an initial data unit from the data unit payload;
combining the initial data unit with data units of another service flow for subsequent transmission; and
reconstructing a new data unit when at least a portion of one of the fragments of the initial data unit is not acknowledged as being received.

14. The method of claim 13 wherein constructing comprises constructing the new data unit using blocks of a same fragment and an untransmitted fragment, the same fragment including both blocks that were acknowledged as being received and blocks that were not acknowledged as being received.

15. The method of claim 13 wherein combining comprises combining the initial data unit with data units of other service flows for subsequent transmission within a single physical-layer burst through a wireless communication channel to a receiving station, and
wherein the method further comprises:
determining when conditions of the channel are degraded; and
rearranging portions of the initial data unit payload to generate smaller data units when the initial data unit is not acknowledged as being received when conditions of the channel are determined to be degraded.

16. The method of claim 15 wherein when the conditions of the channel are not determined to be degraded, the method comprises refraining from rearranging the portions and providing the initial data unit for recombining with data units of other service flows when the initial data unit is not acknowledged as being received.

17. The method of claim 16 wherein the wireless communication channel comprises an orthogonal frequency division multiple access channel.

18. The method of claim 13 wherein the service flow is one of a plurality of service flows, and wherein the method further comprises:
receiving a plurality of service data units for an associated one of the plurality of service flows;
generating data unit payloads for the associated service flow; and
combining data units from the plurality of service flows into a single physical-layer burst.

19. The method of claim 18 wherein the plurality of service flows comprise one or more of a voice, data, multimedia, streaming video and internet communication.

20. The method of claim 18 wherein the generating and constructing are performed by a media access controller of a protocol stack, and wherein the method further comprises:
receiving the service data units for the associated service flow from a higher-level layer of the protocol stack; and
providing the combined data units to a physical layer of the protocol stack for transmission to one or more receiving stations in the single physical-layer burst.

21. The method of claim 20 wherein the physical layer comprises a multicarrier transmitter to transmit orthogonal frequency division multiple access communication signals comprising a plurality of substantially orthogonal subcarriers.

22. The method of claim 20 wherein the physical layer has a variable burst size, and
wherein the method further comprises combining data units from the plurality of service flows into physical-layer bursts of varying burst sizes.

23. The method of claim 13 further comprising:
maintaining a request transmission window of a predetermined size to buffer blocks of transmitted data units until either an acknowledgement is received or a block lifetime expires;
constructing the initial data unit after entering the request transmission window for the initial data unit; and
advancing the request transmission window when at either an acknowledgement for a transmitted block is received or a block lifetime for the transmitted block expires.

24. The method of claim 13 wherein generating the data unit payload comprises separating received service data units into a plurality of the fragments and combines the fragments of the one or more service data units into one or more data unit payloads,
wherein constructing comprises constructing the initial data unit at least by adding a header to the data unit payload, and
wherein the new data unit is reconstructed at least by adding a header to a new data unit payload comprising at least the portion of one of the fragments of the initial data unit is not acknowledged as being received.

25. A wireless communication device comprising:
a physical layer; and
a media access controller comprising a per-flow scheduler to generate a data unit payload from fragments of more than one service data unit of a service flow, a data unit constructor to construct an initial data unit from the data unit payload, a data unit combiner to combine the initial data unit with data units of another service flow for subsequent transmission by the physical layer, and a transmission request handler to reconstruct a new data unit when at least a portion of one of the fragments of the initial data unit is not acknowledged as being received.

26. The wireless communication device of claim 25 wherein the new data unit is constructed using blocks of a same fragment and an untransmitted fragment, the same fragment including both blocks that were acknowledged as being received and blocks that were not acknowledged as being received.

27. The wireless communication device of claim 25 wherein the data unit combiner combines the initial data unit with data units of other service flows for subsequent transmission within a single physical-layer burst through a wireless communication channel to a receiving station, and
wherein when conditions of the channel are determined to be degraded, the transmission request handler rearranges portions of the initial data unit payload to generate smaller data units when the initial data unit is not acknowledged as being received.

28. The wireless communication device of claim 27 wherein when the conditions of the channel are not determined to be degraded, the transmission request handler refrains from rearranging the portions and provides the initial data unit to the data unit combiner for recombining with data units of other service flows when the initial data unit is not acknowledged as being received.

29. The wireless communication device of claim 28 wherein the wireless communication channel comprises an orthogonal frequency division multiple access channel.

30. The wireless communication device of claim 25 wherein the service flow is one of a plurality of service flows,
wherein the per-flow scheduler, the data unit constructor and the transmission request handler are associated with one service flow of the plurality,
wherein the media access controller further comprises a per flow scheduler, a data unit constructor and a transmission request handler for each of the service flows,
wherein the per-flow schedulers each receive a plurality of service data units for an associated one of the service flows and generate data unit payloads for the associated service flow, and
wherein the data unit combiner combines data units provided by the transmission request handlers from the plurality of service flows into a single physical-layer burst.

31. The wireless communication device of claim 30 wherein the plurality of service flows comprise one or more of a voice, data, multimedia, streaming video and internet communication.

32. The wireless communication device of claim 30 wherein the media access controller is one layer of a protocol stack,
wherein the schedulers receive the service data units for the associated service flow from a higher-level layer of the protocol stack, and
wherein the data unit combiner provides the combined data units to the physical layer of the protocol stack for transmission to one or more receiving stations in the single physical-layer burst.

33. The wireless communication device of claim 32 wherein the physical layer comprises a multicarrier transmitter to transmit orthogonal frequency division multiple access communication signals comprising a plurality of substantially orthogonal subcarriers.

34. The wireless communication device of claim 32 wherein the physical layer has a variable burst size, and
wherein the data unit combiner combines data units provided by the transmission request handlers from the plurality of service flows into physical-layer bursts of varying burst sizes.

35. The wireless communication device of claim 25 wherein the transmission request handler maintains a request transmission window of a predetermined size to buffer blocks of transmitted data units until either an acknowledgement is received or a block lifetime expires,
wherein the data unit constructor constructs the initial data unit after entering the request transmission window for the initial data unit,
wherein the transmission request handler advances the request transmission window when at either an acknowledgement for a transmitted block is received or a block lifetime for the transmitted block expires.

36. The wireless communication device of claim 25 wherein the scheduler separates received service data units into a plurality of the fragments and combines the fragments of the one or more service data units into one or more data unit payloads,
wherein the data unit constructor constructs the initial data unit at least by adding a header to the data unit payload, and
wherein the transmission request handler reconstructs the new data unit at least by adding a header to a new data unit payload comprising at least the portion of one of the fragments of the initial data unit is not acknowledged as being received.

37. A system comprising:
a physical layer; and
a substantially omnidirectional antenna coupled to the physical layer; and
a media access control layer comprising:
a per-flow scheduler to generate a data unit payload from fragments of more than one service data unit of a service flow;
a data unit constructor to construct an initial data unit from the data unit payload;
a data unit combiner to combine the initial data unit with data units of another service flow for subsequent transmission by the physical layer using the antenna; and
a transmission request handler to reconstruct a new data unit when at least a portion of one of the fragments of the initial data unit is not acknowledged as being received.

38. The system of claim 37 wherein the new data unit is constructed using blocks of a same fragment and an untransmitted fragment, the same fragment including both blocks that were acknowledged as being received and blocks that were not acknowledged as being received.

39. The system of claim 37 wherein the data unit combiner combines the initial data unit with data units of other service flows for subsequent transmission within a single physical-layer burst through a wireless communication channel to a receiving station,
wherein when conditions of the channel are determined to be degraded, the transmission request handler rearranges portions of the initial data unit payload to generate smaller data units when the initial data unit is not acknowledged as being received, and
wherein when the conditions of the channel are not determined to be degraded, the transmission request handler refrains from rearranging the portions and provides the initial data unit to the data unit combiner for recombining with data units of other service flows when the initial data unit is not acknowledged as being received.

40. A machine-accessible medium that provides instructions, which when accessed, cause a machine to perform operations comprising:
generating a data unit payload from fragments of more than one service data unit of a service flow;
constructing an initial data unit from the data unit payload;
combining the initial data unit with data units of another service flow for subsequent transmission; and
reconstructing a new data unit when at least a portion of one of the fragments of the initial data unit is not acknowledged as being received.

41. The machine-accessible medium of claim 40 wherein the instructions, when further accessed cause the machine to perform operations comprising constructing the new data unit using blocks of a same fragment and an untransmitted fragment, the same fragment including both blocks that were acknowledged as being received and blocks that were not acknowledged as being received.

42. The machine-accessible medium of claim 40 wherein the instructions, when further accessed cause the machine to perform operations further comprising combining the initial data unit with data units of other service flows for subsequent transmission within a single physical-layer burst through a wireless communication channel to a receiving station, and
wherein the operations further comprise:
determining when conditions of the channel are degraded; and
rearranging portions of the initial data unit payload to generate smaller data units when the initial data unit is not acknowledged as being received when conditions of the channel are determined to be degraded,
when the conditions of the channel are not determined to be degraded, the operations comprise refraining from rearranging the portions and providing the initial data unit for recombining with data units of other service flows when the initial data unit is not acknowledged as being received.
